(19) United States
(12) Patent Application Publication
(10) Pub. No.: US 2024/0224876 A9
(43) Pub. Date: Jul. 11, 2024

(54) AGRICULTURAL WAGON

(71) Applicant: Hustler Equipment Limited, Hastings (NZ)

(72) Inventors: Brent Adrian CURRIE, Hastings (NZ); Neville WARD, Ashburton (NZ)

(21) Appl. No.: 18/548,070

(22) PCT Filed: Dec. 22, 2021
(86) PCT No.: PCT/NZ2021/050229

§ 371 Date: Aug. 25, 2023

Related U.S. Application Data
(63) Continuation-in-part of application No. PCT/NZ2021/050024, filed on Feb. 25, 2021.

(51) Int. Cl. A01D 90/14; A01D 90/10; B60P 1/38; B62D 63/08; B65G 23/22; B65G 43/00; F15B 13/04

(52) U.S. Cl. CPC A01D 90/14; A01D 90/105; B60P 1/38; B62D 63/08; B65G 23/22; B65G 43/00; F15B 13/0401; F15B 2211/321; F15B 2211/327; F15B 2211/329

(57) ABSTRACT

An agricultural wagon having a plurality of load sensors between a tow bar and a chassis. The load sensors are configured to sense the load of the wagon. The load sensors may sense the load of the wagon when it is supported on a tow coupling or on a stand. The agricultural wagon also has a collapsible cross conveyor, a lift-out tail gate and plastic hungry boards. The direction in which the cross conveyor feeds out material can be automatically selected based on the position or movement of the cross conveyor.

### FIELD

This invention relates to an agricultural wagon.

### BACKGROUND

Agricultural wagons are used to carry and feed out various materials, particularly loose (i.e. not baled) materials. For example, agricultural wagons can carry silage, meal, maize or magnesium, among other things.

### SUMMARY

According to one example embodiment there is provided an agricultural wagon including:

a compartment configured to store material to be fed from the wagon;

a cross conveyor for selectively feeding the material either from a first side of the wagon in a first mode or from a second side of the wagon in a second mode, wherein the cross conveyor is movable between a first position that is located towards the first side of the wagon and a second position that is located towards the second side of the wagon; and

a conveyor controller that is configured to select whether the cross conveyor operates in the first mode or the second mode, the selection being based on a movement or position of the cross conveyor between the first side of the wagon and the second side of the wagon.

Embodiments may be implemented according to any one of the dependent claims 2 to 22.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings, which are incorporated in and constitute part of the specification, illustrate embodiments of the invention and, together with the general description of the invention given above, and the detailed description of embodiments given below, serve to explain the principles of the invention.

FIG. 1 is an isometric view of an agricultural wagon according to one exemplary embodiment;

FIG. 2 is another view of the agricultural wagon of FIG. 1;

FIG. 3 is a side view of a tow assembly according to one exemplary embodiment;

FIG. 4 is another view of the agricultural wagon of FIG. 1 with a tail gate installed;

FIG. 5 is another view of the agricultural wagon of FIG. 1 with the tail gate uninstalled;

FIG. 6 is a view of the wagon of FIG. 1 with some components removed;

FIG. 7 is another view of the wagon of FIG. 1 with some components removed;

FIG. 8 is an isometric view of a cross conveyor according to one exemplary embodiment;

FIG. 9 is a side view of two coupled hungry boards according to one exemplary embodiment;

FIG. 10 is a side view of two decoupled hungry boards according to one exemplary embodiment;

FIG. 11 is a view of the underside of an agricultural wagon according to an alternative exemplary embodiment;

FIG. 12 is a view of components of the agricultural wagon of FIG. 11; and

FIG. 13 is a schematic view of an exemplary hydraulic system for the agricultural wagon of FIG. 11.

### DETAILED DESCRIPTION

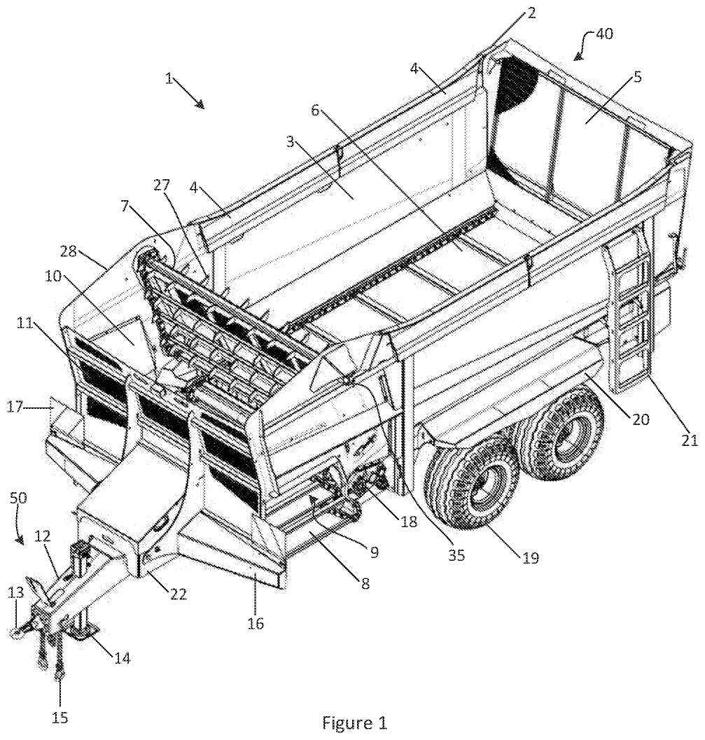

FIG. 1 illustrates an agricultural wagon 1 according to an example embodiment. In the description below, the agricultural wagon will be discussed in the context of feeding out silage, in which case it may be termed a silage wagon. However, this is only one exemplary use and the teachings of the present application are applicable to other kinds of agricultural wagons used for other purposes.

The agricultural wagon 1 has a main body, generally indicated at 40, and a tow assembly generally indicated at 50. The main body 40 can include a holding compartment 2 for receiving material such as silage as well as one or more conveyors for feeding out the material. The tow assembly 50 is used to couple the wagon to an agricultural vehicle such as a tractor. A chassis (the forward extension of which is visible at 22) supports the compartment 2 and other components of the main body. The tow assembly 50 is also connected to the main body 40 via the chassis 22.

The holding compartment 2 is formed by walls that prevent material from falling off the wagon 1. One or more of the walls can be fixed to the body 40. One or more of the walls can be removable or openable. One or more of the walls can include or be constituted by a conveyor. In this example, the compartment 2 is formed by fixed side walls 3, removable tail gate 5 and elevator 7. One or more extension boards can also be provided at the top of one or more of the walls. These may increase the carrying capacity of the wagon by raising the height of the walls and may be known in the industry as “hungry boards”. In the example of FIG. 1, the wagon has four hungry boards 4, two on each side wall 3.

The compartment 2 may have a conveyor in it to transfer material out of the compartment 2 or from one location in the compartment 2 to another. For example, the conveyor may be a screw auger or an endless loop-type conveyor. In the example of FIG. 1, the floor of the compartment 2 has a conveyor 6 in the form of a floor chain 6. This can be used to feed material forwards towards the elevator 7. The elevator 7 picks the material up from the compartment 2, raises it over the elevator 7 and deposits it onto the cross conveyor 8 in the feed out compartment 28. The elevator can have teeth 27 to assist in picking up the material and breaking up any large clumps of material. The conveyor 6 and elevator 7 can be driven by motors, for example hydraulic motors. The motor and gearbox for the floor conveyor is shown at 18. The motor for the elevator 7 is shown at 35.

The wagon 1 has an opening on one or more sides for allowing the material on the cross conveyor 8 to be fed out of the wagon. In the example of FIG. 1, the wagon 1 has two openings, one on each side of the wagon 1, although only one opening 9 is visible in FIG. 1. The cross conveyor 8 can be arranged to feed material out of either side of the wagon 1. An operator can select which direction the cross conveyor 8 transports material in based on which side of the wagon 1 they want to feed material out from. The cross conveyor 8 can also move laterally to control the lateral throw of material fed from the wagon 1. In one example, one or more hydraulic rams could be connected to the cross conveyor to move it laterally. The hydraulic rams could be controlled by a switch, button or other control device on the agricultural vehicle. The control device could be connected to the hydraulic rams by a hydraulic circuit and/or an electric circuit. The cross conveyor 8 can extend further out from the side of the wagon that it feeds material from. This may ensure that the material does not fall under the wheels 19. It may also help to feed material into troughs or to prevent material from being deposited onto a road or track that the wagon 1 travels on. In this example, the cross conveyor 8 extends outwards as far as the outer edges of the wheels 19, although it could extend further in other examples. One or more deflector plates 10 can be provided above the cross conveyor 8 in the feed out compartment 28. These may help to prevent material falling from the elevator out of the opening(s) 9, rather than being properly conveyed out of them by the cross conveyor 8. In particular, the deflector plate(s) can prevent material from falling out of the side other than the one that the cross conveyor 8 is feeding material out from. The deflector plates are placed above each opening to deflect falling material towards the middle of the cross conveyor 8. The deflector plates 10 can extend inwards at least to a point above the outermost end of the cross conveyor 8 so that there is no direct vertical path from the elevator 7 past the deflector plate 10 and out of the opening 9.

The deflector plates 10 could be fixed in place over the cross conveyor or could be movable. For example, the deflector plates 10 could be hinged to the side of the wagon so that they can be folded away when not needed. In another example, the deflector plate(s) 10 could move with the cross conveyor 8. The lower end of the movable deflector plate(s) 10 could be coupled to the cross conveyor 8 by one or more link arms that are pivotably connected to the cross conveyor 8 or to the deflector plate(s) 10. The upper end of the deflector plate(s) could be slidably connected to the side of the wagon. In this arrangement, when the cross conveyor 8 moves laterally towards one side (the feeding side) the lower end of the deflector plate 10 at the other side (the non-feeding side) will be pulled towards the feeding side. The upper end of the deflector plate will slide downwards to allow the lower end of the plate to move towards the feeding side. This can ensure that the deflector plate at the non-feeding side adequately covers the opening at the non-feeding side. This arrangement may be particularly useful when the cross conveyor 8 can move a long way towards the feeding side.

The wagon 1 can also have a front wall 11 that is located across the cross conveyor from the elevator 7. The front wall 11, elevator 7 and side walls 3 provide the sides of the feed out compartment 28. The front wall 11 can be a solid wall or it can have one or more holes in it. Holes may allow an operator on the agricultural vehicle to see into the wagon 1 to monitor its operation and to check on the amount of material in the wagon 1. Alternatively, the front wall 11 may be made of a transparent material, for example a tough plastic such as polycarbonate or acrylic. In the example of FIG. 1, the front wall has mesh panels which provide many small holes for the operator to look through. The tail gate 5 may similarly be formed of a solid wall or may have holes, and it may be formed of transparent material, for example a tough plastic such as polycarbonate or acrylic. In this example, the tail gate 5 also has mesh panels. These examples may allow an operator on the agricultural vehicle to see through the tail gate 5 behind the wagon.

The tow assembly 50 includes a tow bar 12. The tow bar 12 is connected to the chassis of the wagon 1. A tow coupling 13 is provided on the tow bar 12 for coupling the wagon to the agricultural vehicle. The tow assembly 50 also includes a stand 14 to help support the wagon 1 when it is not coupled to the agricultural vehicle. The stand is connected to the tow bar 12. One or more chains 15 may also be provided as a secondary means of coupling the wagon 1 to the agricultural vehicle.

The agricultural wagon 1 can have protective members such as bumpers or nerf bars for protection. In the example of FIG. 1, nerf bars 16 are fitted to the front of the body 40 of the wagon 1 near the cross conveyor 8. These may be particularly useful in protecting the wagon from damage that could otherwise be caused if the wagon were to jack-knife while connected to the agricultural vehicle. Visual indicators 17 can also be provided on the front of the wagon to improve visibility of the front the wagon and help an operator on the agricultural vehicle to judge the position of the front of the wagon 1. The indicators may be brightly coloured and may have a striking design on them.

The wagon 1 also has a guard 20 over the wheels 19. This may act as a mud guard. The guard may also act a step for an operator to stand on, for example to inspect or access the interior of the holding compartment 2 or to install or remove the hungry boards 4. A ladder 21 is also provided on the side of the wagon 1 for accessing the compartment 2 and hungry boards 4.

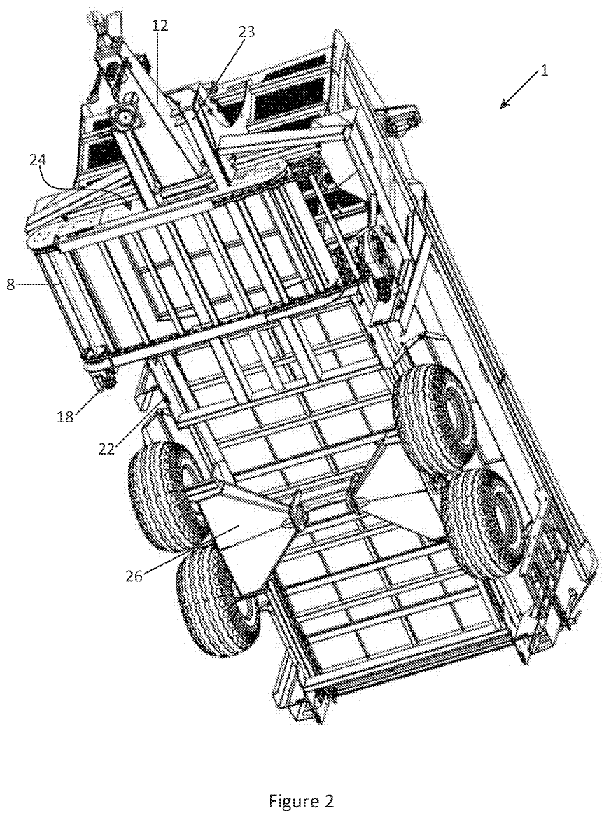

FIG. 2 shows the underside of the agricultural wagon 1. The chassis 22 that supports the main body of the wagon can be seen better in this view. The chassis 22 includes bars 23 that extend forwards to connect to the tow bar 12. The bars 23 can extend through an opening 24 in the cross conveyor 8. This saves space and improves ground clearance beneath the wagon 1.

Also shown in FIG. 2 are the axle support subframes 26. These are mounted beneath the chassis 22 and support the wheels. One or more load sensors can be provided in the axle support subframes 26 or between the subframes 26 and the chassis 22 to measure the load of the wagon on the wheels 19.

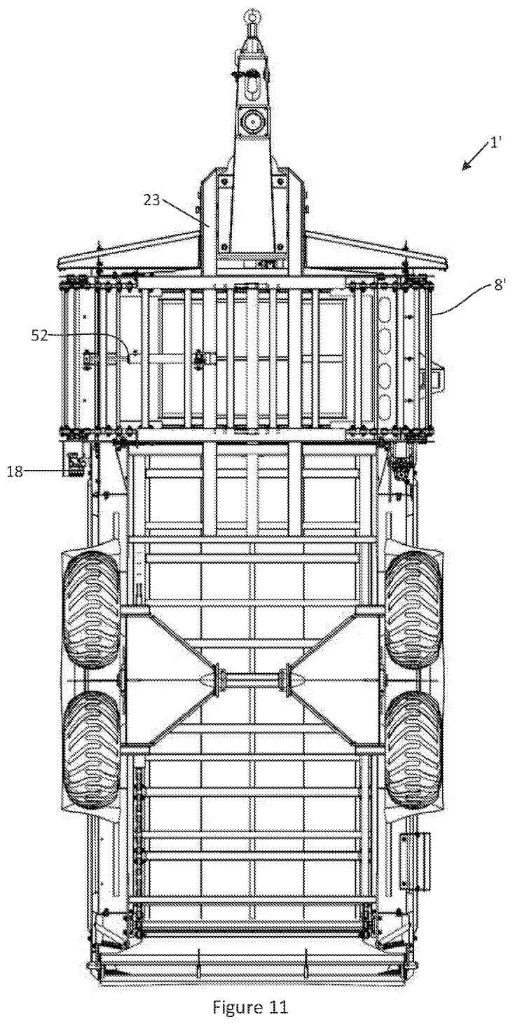

FIG. 2 also shows the motor 18 for driving movement of the cross conveyor 8. The direction of operation of the motor can be reversed to change which side of the wagon material is fed from. In some examples, a user can operate a lever, switch, button or the like on the wagon to change direction of operation of the motor 18. In other examples, for example as described in more detail with reference to FIGS. 11-13, the direction of operation of the motor 18 can be changed without the operator needing to leave the agricultural vehicle (e.g. tractor). The direction of operation of the motor can also be controlled based on the position or movement of the cross conveyor to ensure that the feed direction is suitable for cross conveyor position.

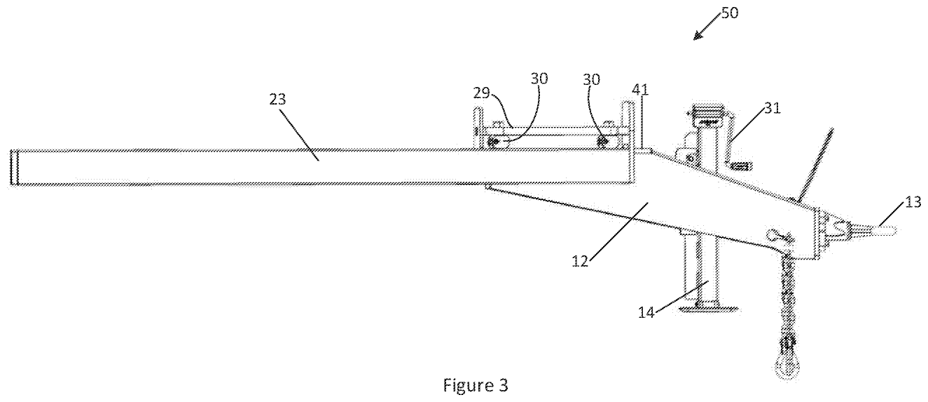

FIG. 3 shows the tow assembly 50 in more detail. As shown in this figure, two load sensors 30 are provided in the tow assembly 50. These are used to measure the load on the wagon. In one example, the load sensors 30 are load cells. The tow bar 12 can be connected to the chassis with the load sensors 30 between the tow bar 12 and the chassis. In the example of FIG. 3, the tow bar 12 includes a mounting plate 41 and the chassis includes a mounting plate 29 on the ends of the bars 23. The mounting plates 29 and 41 are bolted to each other via the load sensors 30.

The load sensors 30 are each configured to sense a load between the tow bar 12 and the chassis. The combination of the outputs of the load sensors 30 can be used to determine the load of the wagon. The outputs of the load sensors 30 may be combined with measurements of the load on the wheels, for example from load sensors in the subframes (item 26 in FIG. 2) or between the subframes and the chassis (item 22 in FIG. 2). In one example, the sum of the outputs of the load sensors represents the full load of the wagon. Depending on the type of sensors used and their configurations, the sensor outputs may be combined in other ways to represent the load on the wagon, for example by subtracting one or more outputs from the other(s) and/or by multiplying one or more outputs by a coefficient before summing them. The combination of outputs may be performed logically in a computing device or the outputs may be combined physically. For example, the load sensor outputs could be voltages which are combined in parallel to produce a combined output. Alternatively, the load sensor could employ a hydraulic fluid in the sensing element that is pressurised dependent on the force applied to it, in which case the hydraulic fluids could be in a common fluid circuit so that the fluid pressure is dependent on the forces on both load sensors. In this example, the load sensors 30 are load cells that are electrically connected in parallel and each output a voltage that is proportional to the force applied to it. The voltages of the two load cells combine in parallel to produce a total voltage that represents the total load on the load cells and the total load of the wagon.

The output from the load sensors 30 can be provided to load-sensing circuitry of the wagon. Alternatively, the output of the load sensors can be provided to the load-sensing circuitry on the agricultural vehicle via an electrical connection between the wagon and the vehicle. The load sensors and/or the load-sensing circuitry can be arranged, calibrated or programmed to determine the gross weight of the wagon, taking into account the weight of a load in the compartment and the wagon itself, or the net weight of the load not including the weight of the wagon itself. The load-sensing circuitry may be a computing device such as a processor or microcontroller. The load-sensing circuitry may be dedicated to the task of sensing wagon loads or could be used for other operations. For example, the on-board computer and/or monitoring circuit of the agricultural vehicle may be used as the load-sensing circuitry.

The use of two load sensors 30 in the tow assembly may allow the weight of the wagon to be determined when the wagon is supported by the tow coupling 13 or a stand (such as the jack 14) without the need to recalibrate the sensors or change a calculation performed by a computing device. Whether the wagon is on the tow coupling 13 or the stand, the combined output of the two load sensors 30 will be the same.

Further load sensors could be provided between the tow bar 12 and the chassis 22 for added redundancy or for weighing greater loads. One or more additional load sensors may be provided in other parts of the agricultural wagon, for example between the floor of the compartment and the chassis 22.

As shown in FIG. 3, the stand is a jack 14 that has a crank handle 31 for extending and retracting the jack 14.

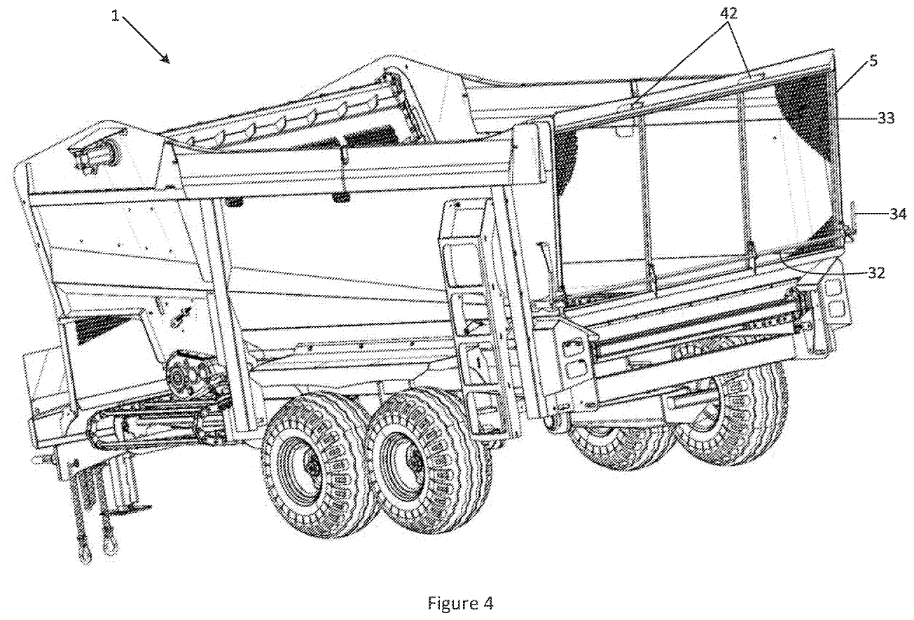

The tail gate 5 is shown installed on the wagon 1 in FIG. 4. The tail gate 5 can be uninstalled from the wagon 1 by lifting. For example, the tail gate 5 can be lifted from its place on the wagon by a tractor, a forklift, a winch etc. The tail gate 5 has holes 42 formed in it to receive fork tines. For example, a forklift can insert fork tines into the holes 42 and lift them to uninstall the tail gate 5. The tail gate 5 can also be installed by lowering it into place. For example, a forklift can carry the tail gate 5 on its forks and lower the forks to lower the tail gate 5 into place on the wagon, before reversing to remove its fork tines from the holes 42.

Guides, runners, rails or the like may be provided in the side walls of the wagon 1 to engage with edges of the tail gate 5 and help to guide it into place during installation and control its withdrawal during uninstallation.

A locking bar 32 can be provided to lock the tail gate 5 into place when it is installed. This can be provided with one or more handles 34 for unlocking and locking the tail gate 5 by hand. Any other suitable lock could be provided to retain the tail gate 5 when installed.

FIG. 5 shows the tail gate 5 in a lifted position. As can be seen, the handle 34 of the locking bar 32 has been turned to release it from the catch 43, allowing the tail gate 5 to be removed.

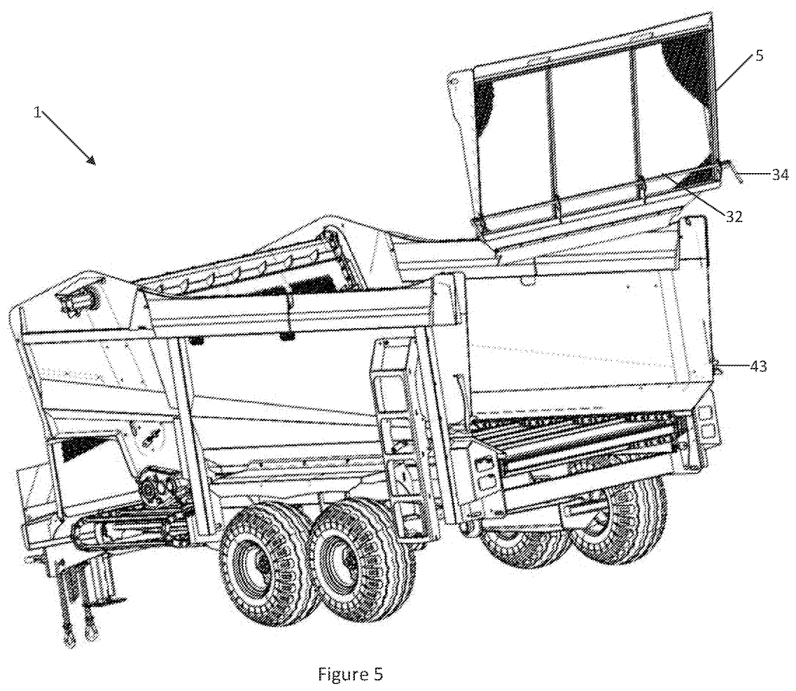

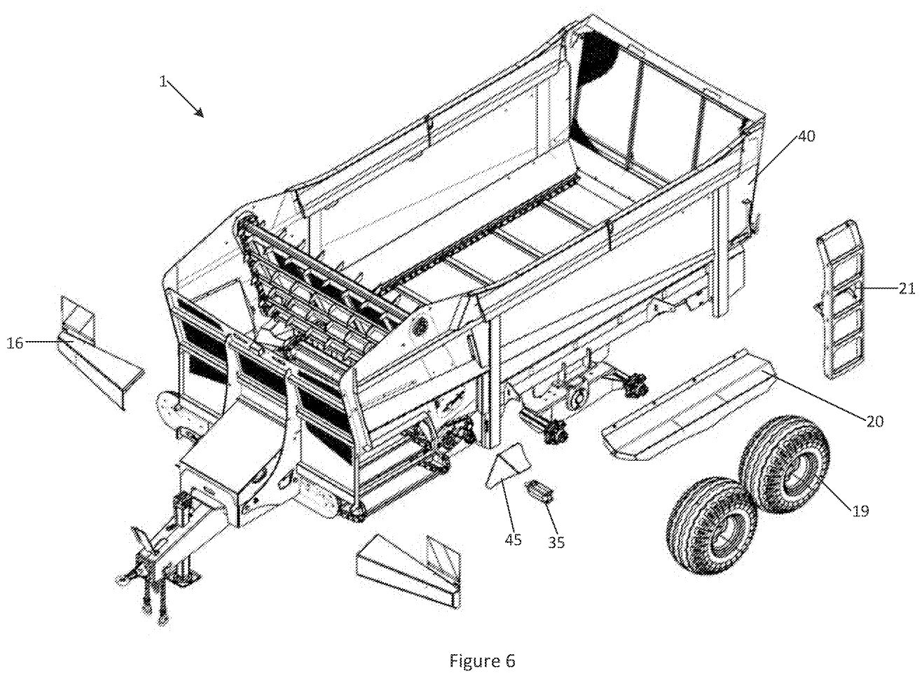

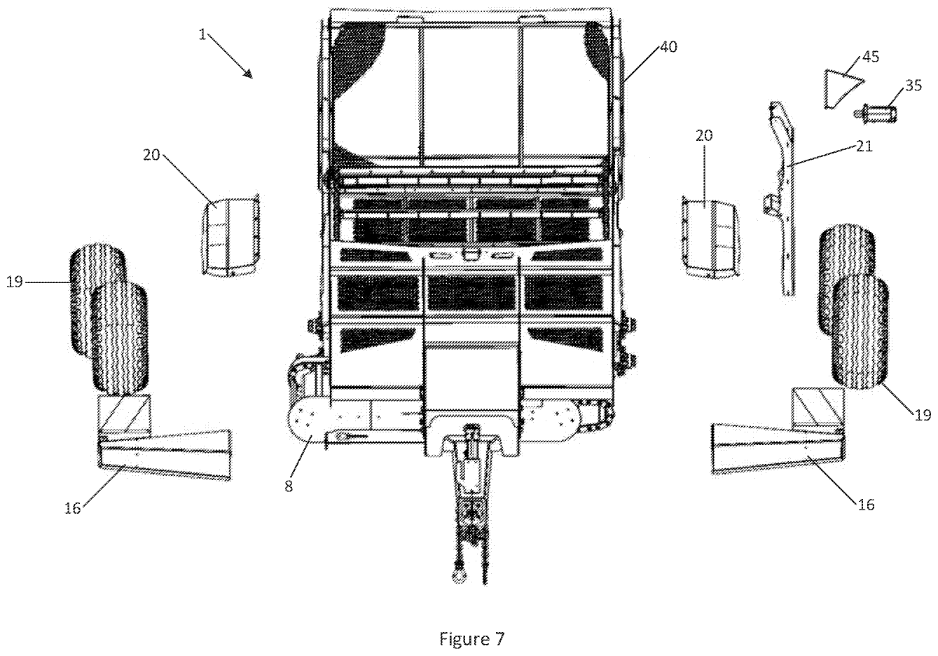

In FIGS. 6 and 7, some components of the wagon 1 have been removed from the main body 40 of the wagon 1. This may help to allow the main body 40 of the wagon 1 to fit within a standard size shipping container. Specifically, the nerf bars 16, wheels 19, wheel guard 20, elevator motor 35, motor guard 45 and ladder 21 have been removed from the main body 40. For transport, these components (and any other removed or not attached components) could be placed in the compartment (labelled 2 in FIG. 1) or shipped separately.

It can be seen in FIG. 7 that the cross conveyor 8 extends out from the side of the main body of the wagon 1. This may be advantageous for feeding out of material like silage. In this extended configuration, the length of the cross conveyor can be such that it extends beyond one or both sides of the main body 40. For transport, it may be advantageous for the cross conveyor to not extend beyond the sides of the main body 40. The cross conveyor can be collapsible to reduce its length as measured along a feed axis, i.e. the left-right axis in the view of FIG. 7. In the collapsed configuration, the cross conveyor does not extend beyond the sides of the main body 40. This may help allow the main body 40 to fit in a standard shipping container.

For shipping, the wagon 1 could be prepared with attachments (e.g. 16, 19, 20, 35, 45 and 21 shown in FIG. 6) detached from the main body and safely packaged in the holding compartment. The cross conveyor would also be in the retracted configuration. After shipping, the attachments can be attached to the main body and the cross conveyor 8 can be put into the extended configuration.

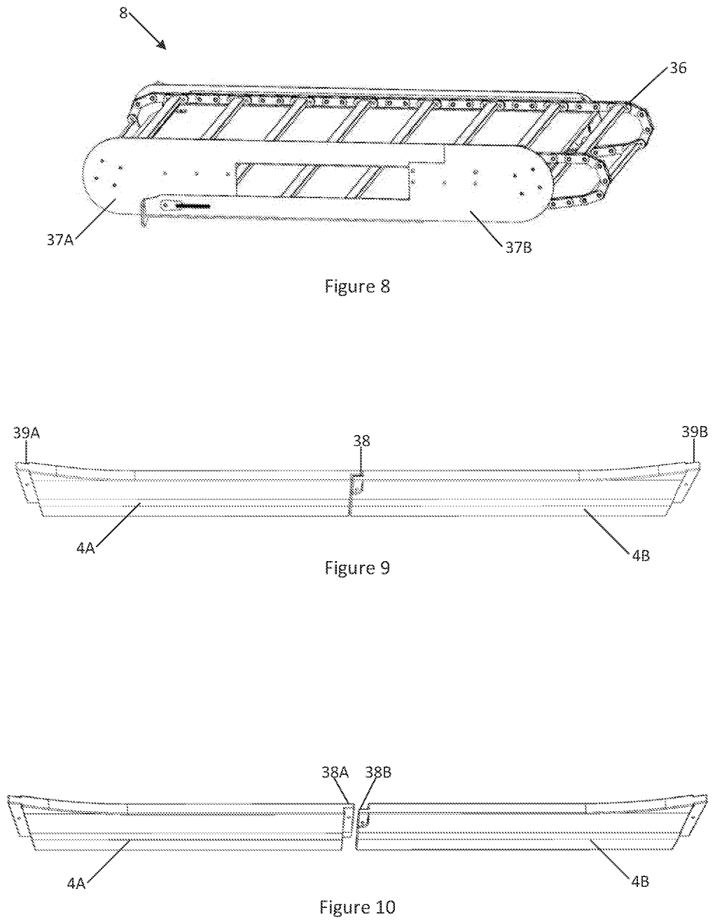

The cross conveyor 8 is shown in isolation in FIG. 8. The cross conveyor 8 includes two frame halves 37A and 37B. The cross conveyor 8 also includes a conveyor chain 36. In this example, the frame halves can slide towards each other to move the cross conveyor 8 from the extended configuration shown into the retracted configuration. In other examples, the cross conveyor could include other collapsible structures such as several bars with chain supports on them, where the bars can slide towards and away from each other to collapse and extend the cross conveyor.

Two hungry boards 4A and 4B are shown in each of FIGS. 9 and 10. The hungry boards can be made of a plastics material. In one example, the material is high-density polyethylene (e.g. PE100). The two hungry boards 4A and 4B can be provided on the same wall of the wagon and can couple to each other to form a continuous barrier. The hungry boards 4A and 4B can be the same shape as each other. This means that any two hungry boards can be put together to make the barrier on the side wall. In this example, the hungry boards are configured to be coupled to each other and used on the same side of the wagon when they are oriented at 180° to each other.

The hungry boards 4A and 4B have couplings 39A and 39B at their outer ends for coupling to the sides of the wagon. The two hungry boards 4A and 4B in this example couple to each other at the coupling 38. As shown in FIG. 10, the coupling 38 is formed between the L-shaped mating ends 38A and 38B of the hungry boards.

FIG. 11 shows an alternative example of an agricultural wagon 1′. This wagon 1′ can include an actuator for driving movement of the cross conveyor 8′ between the left and right sides of the wagon 1′. In the example of FIG. 11, the actuator can be a hydraulic cylinder 52. The cylinder 52 can be mounted between the cross conveyor 8′ and a fixed part of the wagon structure, for example a bar 23 of the wagon's chassis.

The wagon 1′ can include a conveyor controller that selects which side of the wagon 1′ the conveyor 8′ feeds material from depending on the position or movement of the conveyor 8′. This can be done automatically, without the operator needing to operate a separate control device (such as a button or switch on the wagon) to change the feed direction. This may ensure that the conveyor 8′ feeds material from the correct side of the wagon 1′ based on the current or future position of the conveyor 8′. For example, the conveyor controller can select that when the cross conveyor 8′ is at the left of the wagon 1′, it feeds material out from the left side of the wagon 1′ and when the cross conveyor 8′ is at the right it feeds material out from the right of the wagon 1′. This may ensure good clearance between the tyres of the wagon 1′ and the fed out material. Having the feed direction controlled based on the position or movement of the cross conveyor 8′ may also avoid the need for additional hydraulic lines or wires between the wagon 1′ and the vehicle that it is attached to for controlling the feed direction from the vehicle.

In some arrangements, the cross conveyor 8′ position and feed direction can be controlled independently if desired.

In the configuration shown in FIG. 11, the cross conveyor 8′ is at the left of the wagon 1′. The feed direction of the cross conveyor 8′ can be selected to feed material out from the left side of the wagon 1′. When the cross conveyor 8′ is at the right of the wagon 1′, the cross conveyor 1′ can be controlled to feed material out from the right of the wagon 1′.

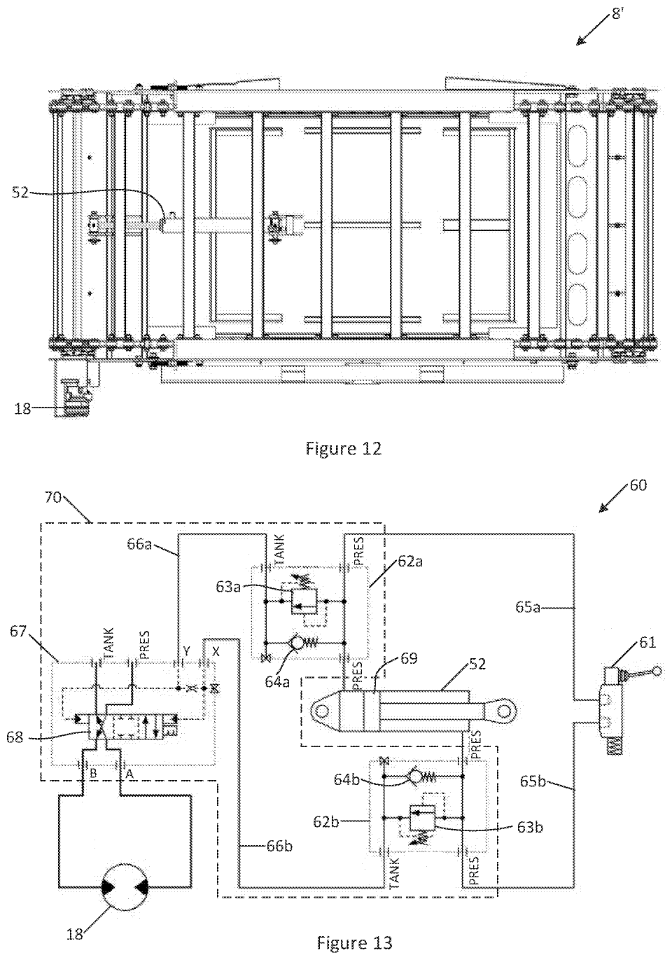

In the example of FIGS. 11 and 12, the cross conveyor 8′ can be operated by a reversible motor. In one example, the reversible motor is a hydraulic motor 18. In other examples, the cross conveyor 8′ could be driven by an electric motor. The reversible motor can rotate in one direction to feed material from one side of the cross conveyor 8′ and can rotate in the opposite direction to feed material from the other side of the cross conveyor 8′.

The cross conveyor 8′, hydraulic cylinder 52 and hydraulic motor 18 are shown in isolation in FIG. 12. The hydraulic cylinder 52 may be extended to any length within its range of travel, which may allow the cross conveyor to be positioned anywhere along a continuum of positions between the two sides of the wagon 1′.

The position or movement of the cross conveyor 8′ could be sensed based on pressure of hydraulic fluid in the hydraulic cylinder 52. Alternatively, the position could be sensed by one or more electronic sensors—such as limit switches, current sensors, voltage sensors, or linear encoders—in electronic communication with the conveyor controller. In this example, the conveyor controller could include one or more electronic flow controllers, for example solenoid valves, for controlling direction of flow of hydraulic fluid through the motor based on the sensed position or movement. Alternatively, the motor could be an electric motor and the conveyor controller could include software and/or hardware components configured to control the direction of operation of the electronic motor.

In another example, the position or movement of the cross conveyor 8′ between the left and right sides of the wagon 1′ could be controlled electronically. For example, there could be a wired or wireless connection between the agricultural vehicle to which the wagon 1′ is connected and the conveyor controller. The operator can send electronic signals from a controller to cause the conveyor controller to move the cross conveyor 8′ side to side, for example using an electrical or hydraulic actuator. The conveyor controller could select the mode of operation (i.e. feed direction) of the cross conveyor 8′ based at least partly on these same signals, from which can be inferred a target position or desired movement of the cross conveyor 8′.

In another example, the position could be sensed by one or more mechanical position sensors such as sliding blocks or fingers placed in the path of the cross conveyor 8′. These could be mechanically coupled to a control element, for example one or more mechanically operated flow direction control valves, in the conveyor controller.

FIG. 13 shows one example of a control system for operating the cross conveyor of FIGS. 11 and 12 to feed material, for controlling the material feeding operation, and for moving the cross conveyor between the two sides of the wagon 1′.

In the example of FIG. 13, the control system is a hydraulic system 60. The hydraulic system 60 includes a manual controller 61 that controls movement of the cross conveyor, a hydraulic cylinder 52 that drives this movement, and a motor 18 that rotates to feed material out from the cross conveyor 8′. The manual controller 61 can be placed in an agricultural machine that is connected to the wagon, e.g. a tractor. The manual controller 61 can include a hydraulic valve to control the supply of the high-pressure hydraulic fluid to the hydraulic cylinder 52 via lines 65a and 65b to drive its extension and retraction. In other examples, the control system can have other types of controllers such as an electronic controller. The electronic controller could be, for example, an onboard computer on the agricultural vehicle, a separate remote controller, or a mobile phone.

The hydraulic system 60 also includes a conveyor controller 70, which can include a hydraulic fluid flow direction control valve 68 and pressure relief valves 63a and 63b. The pressure relief valves 63a and 63b in this example are provided in valve cartridges 62a and 62b. Also provided in the cartridges 62a and 62b are check valves 64a and 64b. The check valves 64a and 64b may allow the pressure relief valves 63a, 63b to be largely bypassed under reverse pressure/reverse flow conditions.

The high pressure (upstream) sides of the pressure relief valves 63a and 63b are connected to the hydraulic cylinder 52 at opposite sides of the piston 69. The low pressure (downstream) sides of the pressure relief valves 63a and 63b are connected to lines 66a and 66b, respectively. The lines 66a and 66b are connected to the pilot ports Y and X, respectively, of the valve cartridge 67 that contains the fluid flow direction control valve 68. The pilot ports X and Y serve as pilot ports for the fluid flow direction control valve 68.

When pressure upstream of either of the valves 63a, 63b exceeds the pressure downstream of the valve by a certain amount, the valve will open and allow pressurised fluid to flow to the respective pilot port of the fluid flow direction control valve 68. The pressure required to open the pressure relief valves 63a, 63b can set a threshold pressure required to cause the fluid flow direction control valve 68 to switch positions. In one example, the threshold can be set to a level that is expected to be reached when the hydraulic cylinder 52 reaches the end of its travel. In one example, the pressure relief valves 63a, 63b can be configured to open at a pressure difference of over about 1000 pounds per square inch (psi) (over about 7000 kPa), over about 1500 psi (over about 10500 kPa) or about 2000 psi (about 14000 kPa).

In another example, the pressure relief valves 63a, 63b can be designed or selected to open at a value that corresponds to movement of the conveyor 8′ above a speed threshold, allowing the operator to move the conveyor 8′ slowly without changing the feed direction or quickly to change the feed direction. This could be done using pressure relief valves 63a, 63b that open at a lower pressure differential, for example or around 1000 psi or 7000 kPa or less. This may allow the position of the cross conveyor 8′ and the feed direction to be controlled independently.

In an alternative example, the pressure relief valves 63a, 63b could be replaced by flow restrictors such as variable-orifice flow restrictors.

The cartridge 67, and therefor the fluid flow control valve 68 of the cartridge 67, is connected to a pressurised hydraulic fluid source at the port labelled PRES and to a low-pressure hydraulic fluid tank at the port labelled TANK. A hydraulic circuit is formed between the PRES port, the fluid flow direction control valve 68, the cartridge ports A and B, the motor 18, and the TANK port. The fluid flow direction control valve 68 controls the direction of flow of hydraulic fluid through the motor 18, depending on which position it is in. The fluid flow control valve in FIG. 13 is a piloted valve with three positions. These include a first position in which port PRES is connected to port A and TANK is connected to port B, and a second position in which PRES is connected to port B and TANK is connected to port A (which is the position shown in FIG. 13). The valve can have detents to help keep the valve in either of these two positions. In the valve 68 shown in FIG. 13, there may also be a middle position in which no flow is permitted between TANK or PRES and A or B. In some examples, this middle position can be omitted and the valve can have only the two positions corresponding to the two different directions of flow through the motor 18.

The pilot ports X and Y of the flow control valve 68 allow the position of the flow control valve 68 to be changed by pressure of hydraulic fluid applied to either port.

In one example the operation of the cross conveyor 8′ can proceed as follows, with reference to FIGS. 11 to 13. The cross conveyor 8′ can initially be positioned at the left of the wagon 1′ as shown in FIG. 11. The hydraulic cylinder 52 would be extended. The hydraulic motor 18 could be driving the conveyor to feed material, such as silage, out from the left side of the wagon 1′. In this configuration, the fluid flow direction control valve 68 would be in the second position (shown in FIG. 13) with pressurised hydraulic fluid flowing from the PRES port to port B and then to the motor 18.

An operator can then choose to move the cross conveyor 8′ to the other side of the wagon 1′, i.e. to the right in FIG. 11. The operator can use the manual controller 61 located in an agricultural vehicle that the wagon 1′ is coupled to. Typically, the manual controller 61 would be near the operator's seat in a tractor. The manual controller 61 is operated to direct pressurised hydraulic fluid along line 65b. This drives the hydraulic cylinder 52 towards retraction. In the state shown in FIG. 13, the cylinder 52 is partly but not fully retracted. When the cylinder 52 is fully retracted, the pressure on line 65b increases above the threshold required to open the pressure relief valve 63b. This causes pressurised hydraulic fluid to flow into line 66b, increasing the pressure on that line. The increased pressure on line 66b, and therefore also at pilot port X, causes the fluid flow direction control valve 68 to change position to the second position. In the new position, the PRES port on the cartridge 67 is connected, via the direction control valve 68, to port A. In this way, the direction of operation of the hydraulic motor 18 is reversed when the cross conveyor 8′ is fully to one side of the wagon 1′. A similar operation can cause the fluid flow direction control valve 68 to switch from the second position to the first position when the hydraulic cylinder 52 is fully extended, due to high pressure on line 65a opening the pressure-relief valve 63a and providing high pressure fluid to the pilot port Y.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An agricultural wagon including:
a compartment configured to store material to be fed from the wagon;
a cross conveyor for selectively feeding the material either from a first side of the wagon in a first mode or from a second side of the wagon in a second mode, wherein the cross conveyor is movable between a first position that is located towards the first side of the wagon and a second position that is located towards the second side of the wagon; and
a conveyor controller that is configured to select whether the cross conveyor operates in the first mode or the second mode, the selection being based on a movement or position of the cross conveyor between the first side of the wagon and the second side of the wagon.

2. The agricultural wagon of claim 1 wherein the conveyor controller is configured to select that the cross conveyor operates in the first mode when the cross conveyor is positioned nearer the first position than the second position and wherein the conveyor controller is configured to select that the cross conveyor operates in the second mode when the cross conveyor is positioned nearer the second position than the first position.

3. The agricultural wagon of claim 2 wherein the conveyor controller is configured to select that the cross conveyor operates in the first mode upon detection that the cross conveyor is in the first position and wherein the conveyor controller is configured to select that the cross conveyor operates in the second mode upon detection that the cross conveyor is in the second position.

4. The agricultural wagon of claim 1 wherein the conveyor controller is configured to select that the cross conveyor operates in the first mode upon detection of the cross conveyor moving towards the first position and wherein the conveyor controller is configured to select that the cross conveyor operates in the second mode upon detection of the cross conveyor moving towards the second position.

5. The agricultural wagon of claim 4 wherein the conveyor controller is configured to maintain a current mode of operation of the cross conveyor despite movements of the cross conveyor between the first and second positions if those movements are below a speed threshold.

6. The agricultural wagon of claim 1 further comprising a reversible motor configured to rotate in a first direction to operate the cross conveyor in the first mode and rotate in a second direction to operate the cross conveyor in the second mode.

7. The agricultural wagon of claim 6 wherein the reversible motor is a hydraulic motor.

8. The agricultural wagon of claim 7 wherein the conveyor controller further comprises a flow direction control valve to control the direction of flow of hydraulic fluid through the hydraulic motor.

9. The agricultural wagon of claim 8 wherein the flow direction control valve is a mechanically operated flow direction control valve.

10. The agricultural wagon of claim 8 wherein the flow direction control valve is a hydraulically operated flow control valve.

11. The agricultural wagon of claim 8 wherein the flow direction control valve is an electrically operated flow direction control valve.

12. The agricultural wagon of claim 1 further comprising an actuator for moving the cross conveyor between the first and second positions.

13. The agricultural wagon of claim 12 wherein the actuator is a hydraulic cylinder.

14. The agricultural wagon of claim 13 wherein the conveyor controller is configured to select the mode of operation of the cross conveyor based on pressure of hydraulic fluid supplied to the hydraulic cylinder.

15. The agricultural wagon of claim 14 wherein a first port on a first side of a piston of the hydraulic cylinder is fluidly connected to a first pilot port of the hydraulically operated flow direction control valve and a second port on a second side of the piston is fluidly connected to a second pilot port of the hydraulically operated flow direction control valve.

16. The agricultural wagon of claim 15 wherein the conveyor controller further comprises a first pressure relief valve connected between the first port of a hydraulic cylinder and the first pilot port and a second pressure relief valve connected between the second port of the hydraulic cylinder and the second pilot port, wherein each pressure relief valve is configured to open and supply hydraulic fluid to the respective pilot port when pressure at the respective side of the piston exceeds a pressure threshold.

17. The agricultural wagon of claim 16 wherein the pressure threshold is selected to be a pressure reached when the hydraulic cylinder reaches the end of its travel.

18. The agricultural wagon of claim 1 wherein the conveyor controller is configured to select the mode of operation based on the position of the cross conveyor, the agricultural wagon further comprising an electronic position sensor in communication with the conveyor controller.

19. The agricultural wagon of claim 1 wherein the conveyor controller is configured to select the mode of operation based on the position of the cross conveyor, the agricultural wagon further comprising a mechanical position sensor coupled to the conveyor controller.

20. The agricultural wagon of claim 1 wherein the cross conveyor is configured to be moved between the first and second positions in response to control signals received from a vehicle to which the agricultural wagon is connected.

21. The agricultural wagon of claim 20 wherein the wagon is configured to be connected to the vehicle by a hydraulic circuit and wherein the movement or position of the cross conveyor is controlled by flow of hydraulic fluid in the circuit.

22. The agricultural wagon of claim 1 wherein the cross conveyor is configured to be positioned at a continuum of positions between the first and second position.

23-52. (canceled)
